(19) United States
(12) Patent Application Publication
(10) Pub. No.: US 2008/0095526 A1
(43) Pub. Date: Apr. 24, 2008

(54) Structure of photographic apparatus

(76) Inventor: Teng-Lung Chang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/582,321

(22) Filed: Oct. 18, 2006

(51) Int. Cl. G03B 19/00

(52) U.S. Cl. 396/429

(57) ABSTRACT

The present invention relates to an improved structure of photographic apparatus, which includes a photographic body including a front side, a backside, and a topside, and a photographic apparatus, which is adapted on the photographic body and includes a base body and a plurality of camera lenses. The base body is pivoted on the photographic body such that the base body has 360-degree rotating capability with respect to the photographic body. The base body has an annular surface for installing the plurality of camera lenses, which is installed at different positions and angles of the annular surface for performing a plurality of photographic operations. In addition, the camera lenses can rotate with the rotation of the base body, and thereby can perform 360-degree successive panoramic photography.

### FIELD OF THE INVENTION

The present invention relates generally to a photographic apparatus, and particularly to an improved structure of photographic apparatus that has dual camera lenses with 360-degree rotating capability for convenience in photographic operation and for extracting images omnidirectionally.

### BACKGROUND OF THE INVENTION

Owing to development of modern technologies and pursuit of pleasure and taste in life, people use extensively electronic apparatuses with photographic and video-recording functionalities such as cameras or video recorders. Communication between people is indispensable for their life and work nowadays. Besides, mobile communication is requested as well. Thereby, handheld communication apparatuses such as mobile phones and PDAs are prevalent widely. Such kind of handheld communication apparatuses further combines photographic and video-recording functionalities such that the popularity and convenience of applications are even enhanced. Accordingly, handheld communication apparatuses with photographic functionality have become obviously the mainstream of mobile communication. In addition, they also have wide space for the development of more functionalities.

The handheld communication apparatuses with photographic functionality in the prior art are shown in FIG. 1 and FIG. 2, which use a mobile phone 90 (cell phone) as an example. The mobile phone 90 has basic equipments such as a display 91 and a keypad 92. At the back (or the front) of the mobile phone 90, a camera lens 93 is installed. The camera lens 93 can perform photography or video recording, and then display images on the display 92. The functional operations thereof are similar to a general camera or a video recorder.

Such mobile phones 90 with photographic functionality in the prior art can perform photographic and video recording operations by means of the camera lens 93. Because the camera lens 93 is adapted to the back (or the front) of the mobile phone 90, while photographing or video recording, it is necessary to aim the mobile phone 90 at the target object to be photographed then the camera lens 93 can cover the target object. However, such kind of operation method frequently results in persecutions or disputes. Thereby, it is not an ideal design. In real life, there are many things worth being or needed to be photographed. Take taking photographs for keeping evidences as an example. When encountering illegal events, if no photographs are taken for keeping evidences immediately, in future days, evidences will vanish and no one can bear witness. If this happens, it is very unfair and unjust for the injured party. On the other hand, if one uses a mobile phone to take photographs directly, which is equivalent to taking pictures using a camera, the action is very noticeable and is very likely to be restrained, or even to incur conflicts and dangerous events. Consequently, danger lurks in the application of a mobile phone for photographing.

As everyone knows, abidance by laws and the public order are supported and maintained by the whole people. By taking advantages of the prevalence of electronic apparatuses with photographic functionality, the apparatuses can be applied as a constructive tool for maintaining law and order such that violence or behaviors of the lawless persons can be photographed for keeping evidences and thereby are unhidden. Accordingly, the lawless persons will be dealt with according to law. The application of such kind of mobile phones (or cameras, video recorders) with photographic functionality as described above thereby brings positive meanings to society.

Furthermore, there is only a single lens in general cameras, video recorders, or mobile phones with photographic functionality. Single lens can take photographs in a certain direction or for a certain scene. For taking photographs in different directions synchronously, at least two cameras or video recorders are needed. However, a single person cannot operate two cameras or video recorders conveniently synchronously. Thereby, it is not possible to take scenes in two different directions instantaneously, which results in regrets for missing real-time images. Accordingly, it is necessary to improve and to breakthrough the drawbacks described above and hence enhancing using convenience. As a result, public welfare is ensured and omnidirectional photographic pleasure is provided.

### SUMMARY

The purpose of the present invention is to provide an improved structure of photographic apparatus that has 360-degree rotating capability for convenience in photographic operation.

Another purpose of the present invention is to provide an improved structure of photographic apparatus that has dual camera lenses for convenience in omnidirectional photographic operation instantaneously and synchronously.

Another purpose of the present invention is to provide an improved structure of photographic apparatus that has a positive function of taking photographs for keeping evidences without inducing conflicts or danger. Thereby, it can bring positive significance to the society.

Another purpose of the present invention is to provide an improved structure of photographic apparatus that can change photographic direction by way of an easy operation, and further has the function of successive panoramic photography for increasing pleasure and recording life omnidirectionally.

The major components for achieving the purposes described above include a photographic body including a front side, a backside, and a topside, and a photographic apparatus, which is adapted on the photographic body and includes a base body and a plurality of camera lenses. The base body is pivoted on the photographic body such that the base body has 360-degree rotating capability with respect to the photographic body. The base body has an annular surface for installing the plurality of camera lenses, which is installed at different positions and angles of the annular surface for performing a plurality of photographic operations. In addition, the camera lenses can rotate with the rotation of the base body, and thereby can perform 360-degree successive panoramic photography.

In order to make the structure and characteristics as well as the effectiveness of the present invention to be further understood and recognized, the detailed description of the present invention is provided as follows along with preferred embodiments and accompanying figures.

### BRIEF DESCRIPTION OF THE DRAWINGS

FIG. 1 shows a front-side schematic diagram of a mobile phone with photographic functionality according to the prior art;

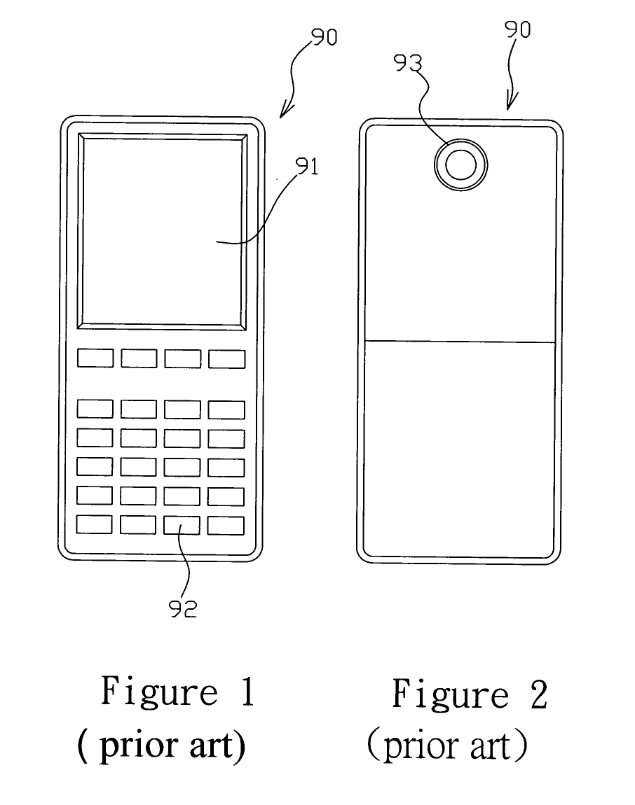

FIG. 2 shows a backside schematic diagram of a mobile phone with photographic functionality according to the prior art;

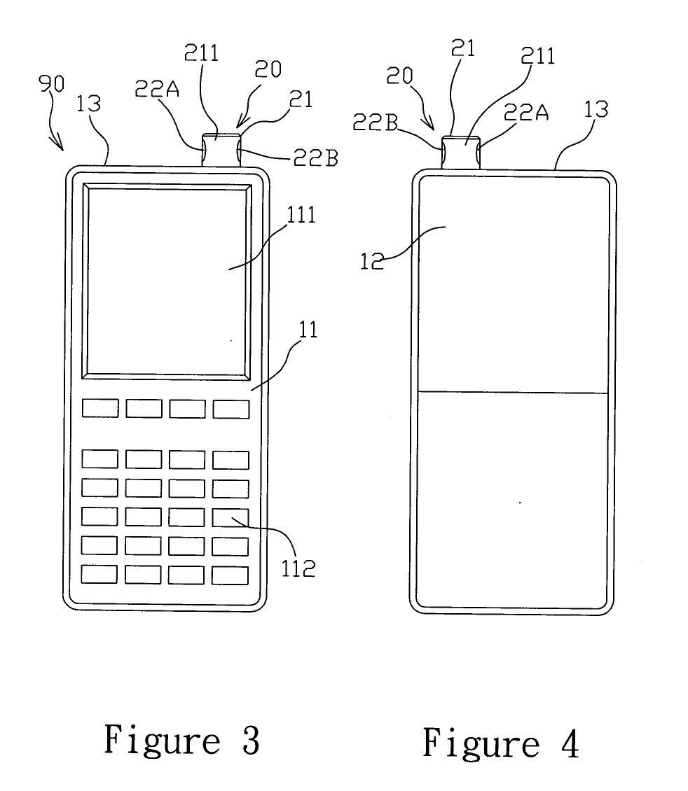

FIG. 3 shows a front-side schematic diagram according to a preferred embodiment of the present invention;

FIG. 3A shows a front-side schematic diagram of dual lenses installed apart according to a preferred embodiment of the present invention;

FIG. 4 shows a backside schematic diagram according to a preferred embodiment of the present invention;

FIG. 5 shows a structural schematic diagram of the photographic apparatus according to a preferred embodiment of the present invention;

FIG. 6 shows a schematic diagram of photographic operations according to a preferred embodiment of the present invention;

FIG. 7 shows a schematic diagram of the base body according to another preferred embodiment of the present invention;

FIG. 8 shows a schematic diagram of the photographic apparatus according to another preferred embodiment of the present invention; and

FIGS. 9A, 9B, and 9C show schematic diagrams of the photographic apparatus according to other preferred embodiments of the present invention.

### DETAILED DESCRIPTION

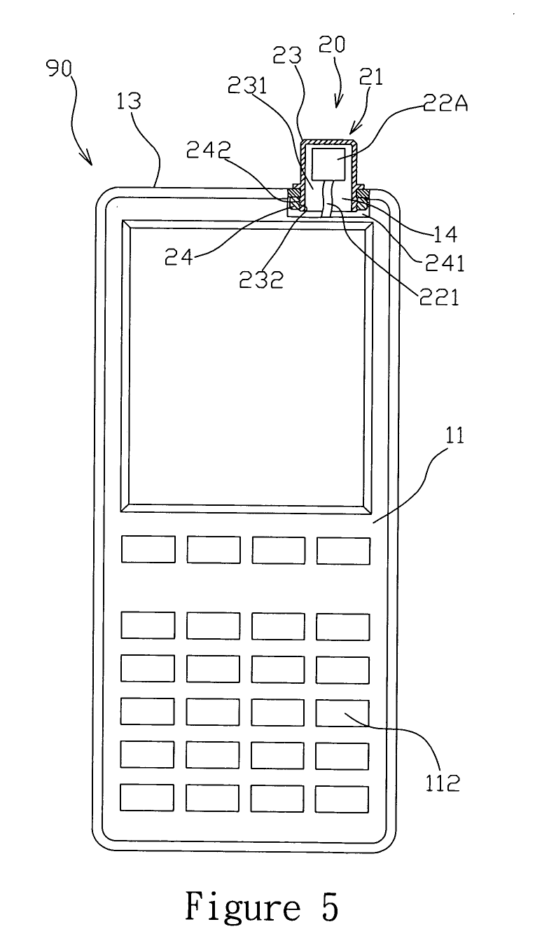

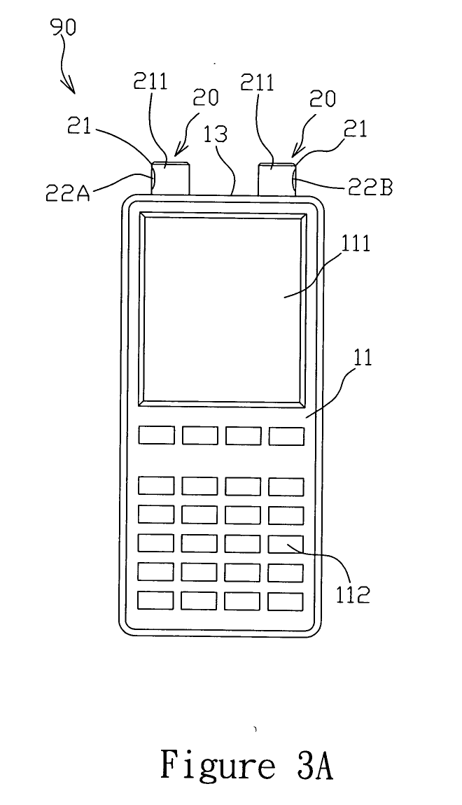

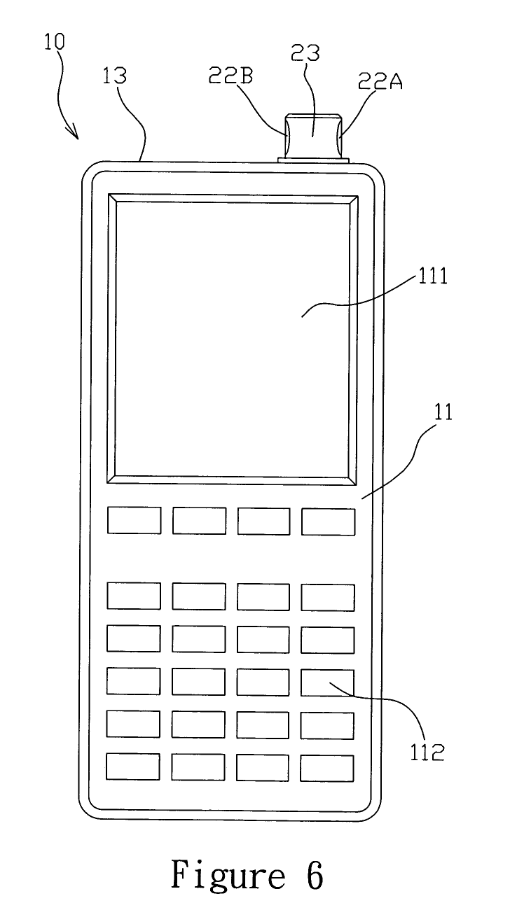

As shown in FIG. 3 and FIG. 4, the improved structure of the photographic apparatus according to the present invention is described by using a mobile phone with photographic functionality. The mobile phone 90 includes a photographic body 10 and a photographic apparatus 20. The photographic body 10 ha a front side 11, a backside 12, and a topside 13. The front side 11 includes a display 111 and a keypad 112. Here, a camera is used as an embodiment of the photographic body 10. The display 111 is on the backside of the camera. The photographic apparatus 20 is installed on the topside 13 of the photographic body 10, and includes a base body 21 and two camera lenses 22A, 22B. The base body 21 is pivoted on the topside of the photographic body 10, and is used for making the base body 10 have 360-degree rotating capability with respect to the photographic body 10. The base body 21 has an annular surface 211. On proper positions of the annular surface 211 of the base body 21, the camera lenses 22A, 22B are installed. For example, the camera lens 22A is installed on the opposite side (that is, a 180-degree difference) of the camera lens 22B, or is installed on other different angles (such as a 90-degree difference) from the camera lens 22B. Thereby, it can be used for photographic operations in different directions. Besides, the camera lenses 22A, 22B can be installed apart on the photographic body 10 (as shown in FIG. 3A), and can have functional features of 360-degree omnidirectional photography and successive panoramic photography. The base body 21 can further be adjusted with arbitrary rotational angles in three dimensions (not shown in figures).

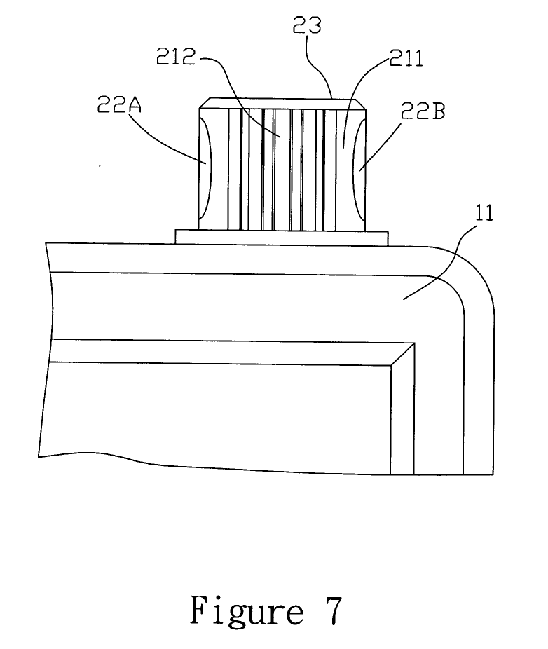

FIG. 5 shows a structural schematic diagram of the photographic apparatus 20 according to a preferred embodiment of the present invention. The base body 21 includes a top base 23, which is used for installing the annular surface 211 and a bottom base 24 at the bottom. The top base 23 has a central channel 231 and inner threads 232. The central channel 231 is used for a signal line 221 of the camera lenses 22 connecting down to a circuit board (not shown in the figure) with photographic functionality in the photographic body 10. The bottom base 24 is pivoted movably in a pivoting groove 14 on the topside 13 of the photographic body 10. The bottom base 24 has a central channel 241 and outer threads 242, and is communicating with the central channel 231 of the top base 23. The outer threads 242 make the bottom base 24 mount by threads with the top base 23 for assembly convenience. In addition, the tope base 23 of the assembled photographic apparatus 20 protrudes appropriately the topside 13 of the photographic body 10 for easier photographic operations, and for the base body 21 being able to perform rotation operations with respect to the photographic body 10.

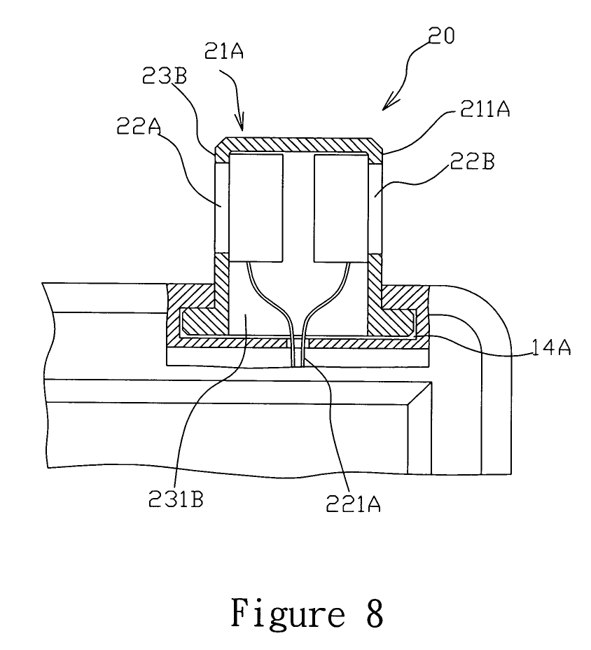

Thereby, when a user rotates the top base 23, the camera lenses 22A, 22B rotate accordingly at the same time. As shown in FIG. 6, when the camera lenses 22 rotate to flanks of the photographic body 10, the user can take photographs of both sides by means of the camera lenses 22A, 22B without the need of firstly pointing the front side 11 or backside 12 of the photographic body 10 to the targets to be taken. Consequently, adjustment is achieved rapidly for instantaneous photography. Furthermore, the camera lenses 22A, 22B can have successive frames presented in accordance with successive rotation of the top base 23. Thereby, the demand and pleasure of successive panoramic photography can be achieved.

In addition, it is possible to choose either one of the camera lenses 22A, 22B, or both of the lenses for photography. When only one of the lenses is chosen, the display 111 will display the frames taken by the lens. On the other hand, when both of the lenses are selected, the display 111 uses picture-in-picture or split frame to display frames taken by the camera lenses 22A, 22B. Dual-frame technologies such as picture-in-picture or split frame can be realized by current technologies, and will not be described further.

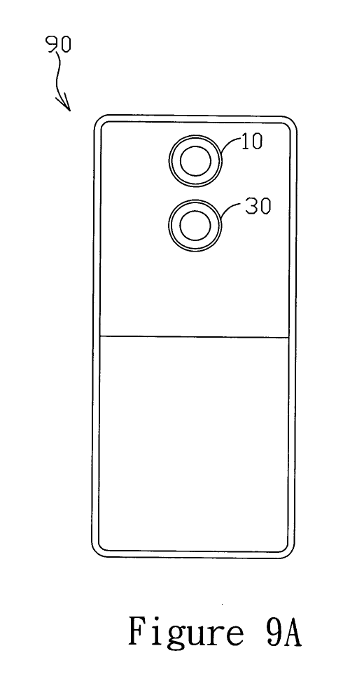

In FIG. 7, the part on the annular surface 211 of the top base 23 other than the camera lenses 22A, 22B can further have uneven stripes 212. The uneven stripes 212 can help the rotation operation of the top base 23. Besides, the rotation operation of the top base 23 can be controlled by electronics and mechanics so that automatic rotation and automatic selection adjustment can be achieved.

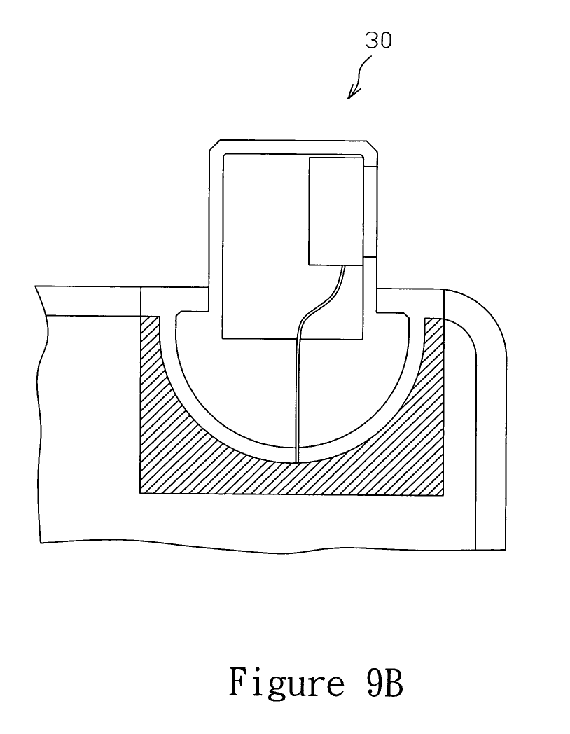

FIG. 8 shows a schematic diagram of the photographic apparatus 20 according to another preferred embodiment of the present invention. The base body 21A is movably pivoted in a pivoting groove 14A on topside of the photographic body 10. The base body 21A includes a top base 23B for installing the annular surface 211A. The top base 23B has a central channel 231B, which is used for a signal line 221A of the camera lenses 22A, 22B connecting down to a circuit board (not shown in the figure) with photographic functionality in the photographic body 10. In one preferred embodiment of the present invention, the pivoting groove 14A has a proper space and an ascending and descending mechanism (not shown in the figure) is adapted at the bottom of the top base 23B such that the top base 23B and the camera lenses 22A, 22B can have the function of protruding by ascending and hiding by descending.

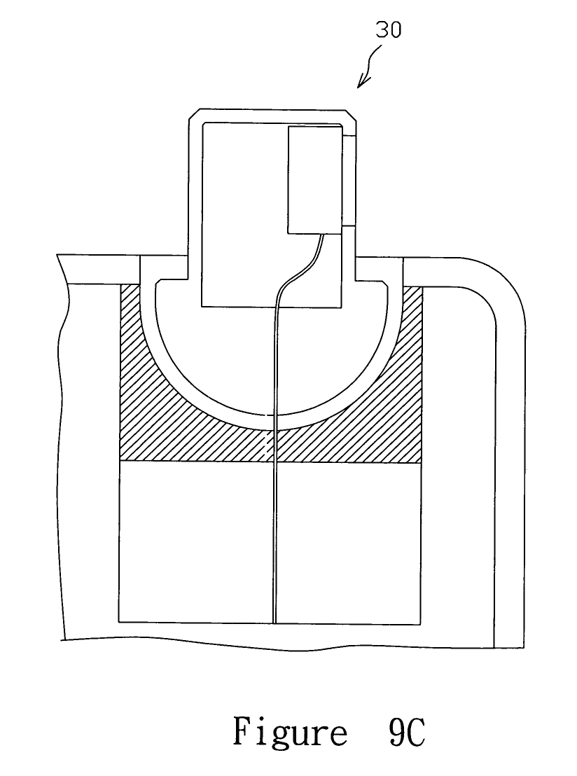

As shown in FIGS. 9A, 9B, and 9C, the photographic apparatus can be installed on the front side 11, the backside 12, or the topside 13 of a mobile phone 90 or any other photographic apparatus. At present, single-lens cameras or mobile phones with photographic functionality have only a single photographic apparatus 10, not two or a plurality of photographic apparatuses 30. Besides, the single photographic apparatus 10 in the prior art is fixed type or is able to rotate in 360 degrees only on a plane. The photographic apparatus 30 according to the present invention provides can rotate with arbitrarily angles in three dimensions. It can be either protruding the body of the mobile phone (as shown in FIG. 9B), or be hidden in the body thereof (as shown in FIG. 9C), and thereby help adjustments in three dimensions.

The improved structure of the photographic apparatus according to the present invention can rotate in 360 degrees for photographing in different angles, thus can improve the drawbacks of the need of pointing the front side or the backside of a mobile phone to the target to be taken. Thereby, photography can be performed conveniently and safely. Handheld communication apparatuses with photographic functionality or webcams can provide not only pleasure to life, but also positive meaning to the society by taking advantage of its non-arresting feature. Consequently, society order can be maintained.

Accordingly, the present invention conforms to the legal requirements owing to its novelty, unobviousness, and utility. However, the foregoing description is only a preferred embodiment of the present invention, not used to limit the scope and range of the present invention. Those equivalent changes or modifications made according to the shape, structure, feature, or spirit described in the claims of the present invention are included in the appended claims of the present invention.

1. An improved structure of photographic apparatus, comprising:
a photographic body, having a front side, a backside, and a topside; and
a photographic apparatus, which is adapted on the photographic body, the photographic apparatus comprising a plurality of base bodies and a plurality of camera lenses, and the plurality of camera lenses being adapted on the plurality of base bodies.

2. The improved structure of photographic apparatus as claim 1, wherein the plurality of camera lenses is preferably two camera lenses.

3. The improved structure of photographic apparatus as claim 1, wherein the base body is preferably pivoted on the topside of the photographic body.

4. The improved structure of photographic apparatus as claim 2, wherein the front side or the backside of the photographic body has a display.

5. The improved structure of photographic apparatus as claim 1, wherein the base body has a top base of an annular surface and a bottom base at the bottom.

6. The improved structure of photographic apparatus as claim 5, wherein the top base mounts with the bottom base by threads.

7. The improved structure of photographic apparatus as claim 5, wherein a central channel is adapted in the top base and another central channel is adapted in the bottom base, both central channels communicating with each other.

8. The improved structure of photographic apparatus as claim 1, wherein a display is connected with the camera lenses and display has dual frames.

9. The improved structure of photographic apparatus as claim 5, wherein other part on the annular surface is related to the camera lenses and the other part on the annular surface has uneven stripes for rotation operations.

10. The improved structure of photographic apparatus as claim 1, wherein the plurality of base bodies are controlled by electronics and mechanics so that a automatic rotation is achieved.

11. The improved structure of photographic apparatus as claim 1, wherein the photographic body has a pivoting groove for installing the base body.

12. The improved structure of photographic apparatus as claim 1, wherein the base body has an ascending and descending mechanism for ascending and descending the base body.

13. The improved structure of photographic apparatus as claim 1, wherein the base body is pivoted on the photographic body such that the base body has 360-degree rotating capability with respect to the photographic body, and the base body has an annular surface for installing the plurality of camera lenses, which are installed at different positions and angles of the annular surface for performing the photographic operation, and the camera lenses rotate with the rotation of the base body for performing 360-degree successive panoramic photography.
